(19) United States
(12) Patent Application Publication
(10) Pub. No.: US 2025/0265609 A1
(43) Pub. Date: Aug. 21, 2025

(54) TRANSACTION METHOD, TRANSACTION SYSTEM, AND TRANSACTION PROGRAM

(71) Applicant: NIPPON TELEGRAPH AND TELEPHONE CORPORATION, Tokyo (JP)

(72) Inventors: Yoshikazu KUSUMI, Musashino-shi, Tokyo (JP); Kanji YOSHITAKE, Musashino-shi, Tokyo (JP)

(21) Appl. No.: 18/567,425

(22) PCT Filed: Jun. 9, 2021
(86) PCT No.: PCT/JP2021/021920

§ 371 Date: Dec. 6, 2023

(51) Int. Cl. G06Q 30/0202; G06Q 10/0834; G06Q 30/0201; G06Q 50/02

(52) U.S. Cl. CPC G06Q 30/0202; G06Q 10/08345; G06Q 30/0206; G06Q 50/02

(57) ABSTRACT

A transaction method includes: a production quantity acquisition step of acquiring a predicted production quantity of an agricultural product on a predetermined future date for each producer (P1); a demand acquisition step of acquiring a predicted demand for the agricultural product on the predetermined date for each purchaser (P2); and a matching step of performing matching between the predicted production quantity of each producer (P1) and the predicted demand of each purchaser (P2) on the predetermined date. The transaction method also includes a notification step of notifying a producer (P1) for which the matching has been established of a delivery destination desired by a purchaser (P2) for which the matching has been established, information of the agricultural product to be delivered, and the predetermined date.

### TECHNICAL FIELD

The present invention relates to a transaction method, a transaction system, and a transaction program.

### BACKGROUND ART

As a method for trading agricultural products, a technology disclosed in Non Patent Literature 1 is known. Non Patent Literature 1 discloses as follows. When agricultural products are traded between producers and purchasers such as brokers and retailers, the agricultural products produced in various regions are concentrated in a wholesale market in a large city such as a central wholesale market. Thereafter, in the wholesale market, a wholesale company and a purchaser make a deal, and farm products purchased by the purchaser are transported to a store or the like and sold to general customers.

The reason why agricultural products are concentrated in a wholesale market is that wholesale markets in large cities have a large demand, and this makes it easier to establish business transactions.

### CITATION LIST

### Non Patent Literature

Non Patent Literature 1: Material 1 for the 43rd review meeting on implementation of the Council for Industrial Competitiveness, https://www.kantei.go.jp/jp/singi/keizaisaisei/jjkaigou/dai43/siryou1.pdf

### SUMMARY OF INVENTION

### Technical Problem

However, in the technology disclosed in Non Patent Literature 1, a farm product produced at a place of production needs to be transferred through a distribution channel for delivery to a collection center, a wholesale market, or a retail store, and the agricultural product needs to be transferred over a long distance and for a long time. Furthermore, there are some cases where an agricultural product is delivered from a rural area to a market near a large city, and then delivered again to a rural area. This has caused a problem in that the cost of delivery increases and the agricultural product becomes less fresh.

The present invention has been made in view of the above circumstances, and is aimed at providing a transaction method, a transaction system, and a transaction program capable of shortening a distribution channel for transferring an agricultural product.

### Solution to Problem

An aspect of the present invention provides a transaction method for trading agricultural products between producers and purchasers, the transaction method including: a production quantity acquisition step of acquiring a predicted production quantity of an agricultural product on a predetermined future date for each producer; a demand acquisition step of acquiring a predicted demand for the agricultural product on the predetermined date for each purchaser; a matching step of performing matching between the predicted production quantity of each producer and the predicted demand of each purchaser on the predetermined date; and a notification step of notifying a producer for which the matching has been established of a delivery destination desired by a purchaser for which the matching has been established, information of the agricultural product to be delivered, and the predetermined date.

An aspect of the present invention provides a transaction system for trading agricultural products between producers and purchasers, the transaction system including: a production quantity acquisition unit that acquires a predicted production quantity of an agricultural product on a predetermined future date; a demand acquisition unit that acquires a predicted demand for the agricultural product on the predetermined date for each purchaser; a transaction control unit that matches the predicted production quantity with the predicted demand on the predetermined date; and a notification unit that notifies a producer for which the matching has been established of a delivery destination desired by a purchaser for which the matching has been established, information of the agricultural product to be delivered, and the predetermined date.

An aspect of the present invention provides a transaction program for causing a computer to function as the transaction system described above.

### Advantageous Effects of Invention

According to the present invention, it is possible to shorten a distribution channel for transferring an agricultural product.

### BRIEF DESCRIPTION OF DRAWINGS

FIG. 1 is a block diagram illustrating a configuration of a transaction system according to a first embodiment, an arithmetic device, and peripheral equipment thereof.

FIG. 2 is a flowchart illustrating a processing procedure of the transaction system according to the first embodiment.

FIG. 3 is an explanatory diagram illustrating an example of labels included in predicted production quantity information, predicted quality information, predicted selling information, and predicted demand information.

FIG. 4 is a block diagram illustrating a configuration of a transaction system according to a second embodiment, an arithmetic device, and peripheral equipment thereof.

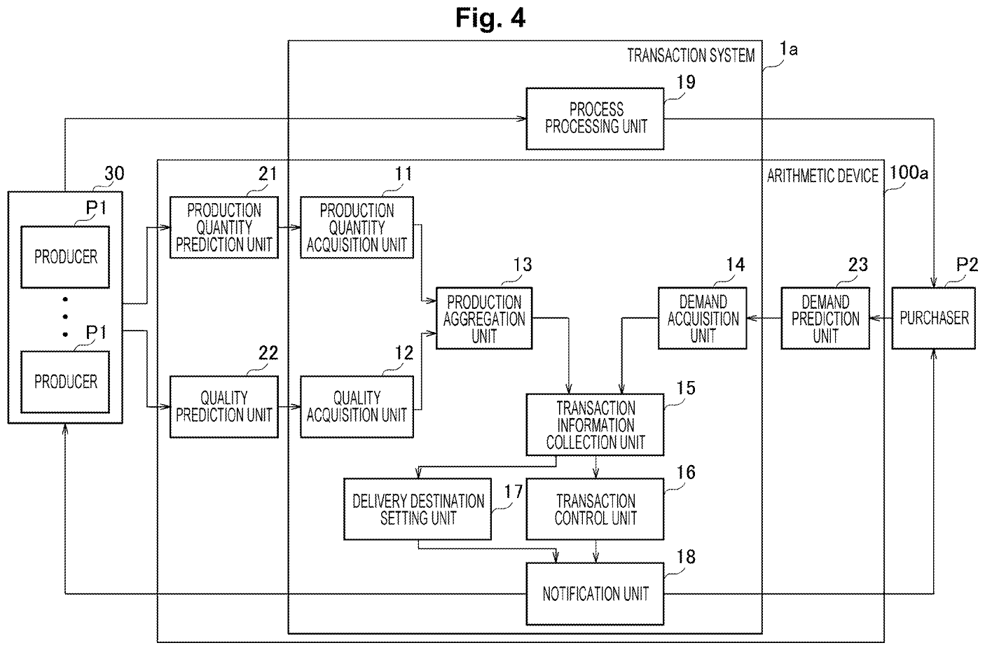

FIG. 5A is a first partial diagram of a flowchart illustrating a processing procedure of the transaction system according to the second embodiment.

FIG. 5B is a second partial diagram of the flowchart illustrating the processing procedure of the transaction system according to the second embodiment.

FIG. 6 is a block diagram illustrating a configuration of a transaction system according to a third embodiment, an arithmetic device, and peripheral equipment thereof.

FIG. 7 is a flowchart illustrating a processing procedure of the transaction system according to the third embodiment.

FIG. 8 is a block diagram illustrating a hardware configuration of the present embodiment.

### DESCRIPTION OF EMBODIMENTS

Hereinafter, embodiments of the present invention will be described with reference to the drawings.

### Configuration of First Embodiment

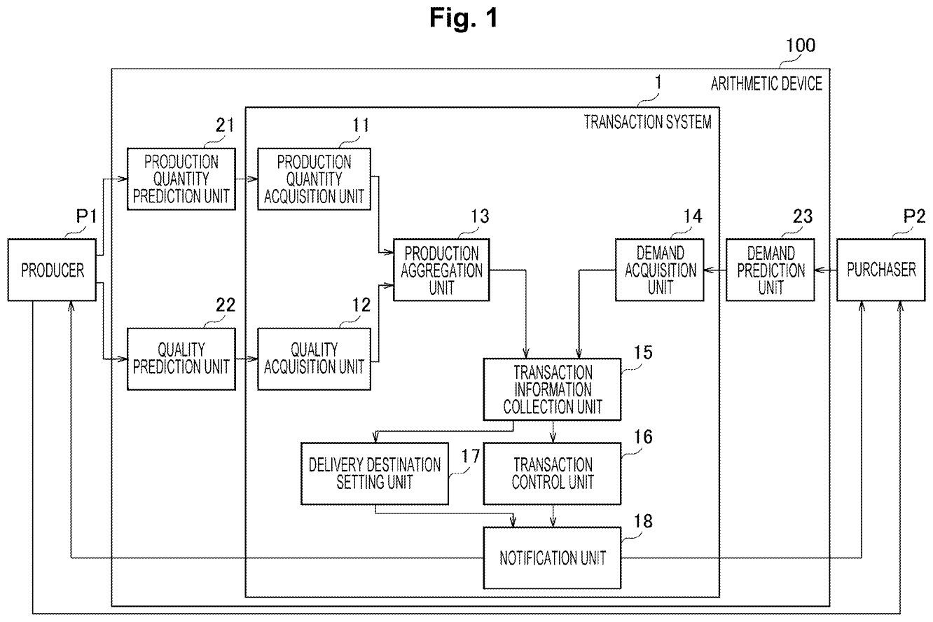

FIG. 1 is a block diagram illustrating a configuration of an arithmetic device 100 including a transaction system 1 according to a first embodiment and peripheral equipment thereof. The transaction system 1 implements transactions of agricultural products between producers P1 and purchasers P2 such as brokers and retailers in a virtual space connected by a communication network.

First, an overview of the present embodiment will be described. The transaction system 1 according to the present embodiment predicts a production quantity of an agricultural product on a future date. At the same time, the transaction system 1 acquires demands for the agricultural product on the future date. The transaction system 1 performs matching between a production quantity and a demand of the agricultural product on a predetermined future date such that the production quantity is allocated to any of the demands.

After performing the matching, the transaction system 1 allocates purchasers and purchase quantities which have been matched according to the production quantity predicted for producers (of a predetermined unit). The transaction system 1 notifies the producers of information such as a predetermined future date on which transactions are to be implemented, the matched agricultural product, demand quantities, purchasers, and transaction amounts. On the basis of the information given, the producers send the agricultural product directly to the purchasers on the predetermined future date. That is, the transactions on the predetermined future date are automatically completed, and the producers only need to send the agricultural product to the purchasers according to the information given. Furthermore, as compared with deals using existing markets, it is not necessary to concentrate the agricultural product, and this allows to reduce transportation costs and shorten the time between harvesting and delivering agricultural products to the purchasers.

In the present embodiment, an example will be described in which delivery sources of the agricultural product are the producers P1, and transactions with the purchasers P2 are implemented on a producer-by-producer basis. In addition to “on a producer-by-producer basis”, the delivery sources of the transactions may be on a shipping organization-by-shipping organization basis, the shipping organization being constituted by a plurality of producers, on a region-by-region basis, the region being a region to which the producers belong, on a market-by-market basis, or on a business operator-by-business operator basis.

The “agricultural products” described in the present embodiment refer to plants produced or collected in fields, rice fields, farms, orchards, mountain forests, and oceans. The agricultural products include fruits and vegetables, rice, fruits, mushrooms, fresh flowers, house plants, seaweed, and livestock feed.

As illustrated in FIG. 1, the arithmetic device 100 includes each component of the transaction system 1, a production quantity prediction unit 21, a quality prediction unit 22, and a demand prediction unit 23.

The production quantity prediction unit 21 predicts the future production quantity of an agricultural product produced by a producer P1 for each future date. The production quantity prediction unit 21 is equipped with, for example, an artificial intelligence (AI) system using machine learning. Supervised learning that is generally used can be adopted as the machine learning.

The production quantity prediction unit 21 predicts the production quantity of the agricultural product on a predetermined future date by using a learning model in which future climate/weather information, information indicating a relationship between the past climate/weather information and the production quantity, information regarding the land that affects the degree of growth of the agricultural product (e.g., pH), and the like are used as training data. Information regarding the production quantity in the future predicted by the production quantity prediction unit 21 is hereinafter referred to as “predicted production quantity information”.

The present embodiment shows an example of predicting the production quantity of an agricultural product on a predetermined future date, but, for example, the production quantity of the agricultural product in a predetermined period such as two days, three days, or one week in the future may be predicted. In addition, a heuristic model such as an effective accumulated temperature method may be used instead of the machine learning.

The quality prediction unit 22 predicts the quality of the agricultural product for each future date, regarding the agricultural product produced by the producer P1. The quality of the agricultural product includes functional components, sugar content, and acidity of the agricultural product. Similarly to the production quantity prediction unit 21 described above, the quality prediction unit 22 uses an AI system to predict the quality of the agricultural product on a predetermined future date.

For example, taking the sugar content as an example, it is possible to use a model that has learned past weather data at the place of production of the agricultural product and the sugar content of the farm product harvested when the weather data was acquired. Note that subjective evaluation may be used as long as the quality can be predicted. Information regarding the quality in the future predicted by the quality prediction unit 22 is hereinafter referred to as “predicted quality information”. Similarly to the predicted production quantity information, a heuristic model may be used. Alternatively, a learned model that has been trained to simultaneously estimate the predicted production quantity information and the predicted quality information may be used.

The demand prediction unit 23 predicts demands for the agricultural product desired by the purchaser P2 for each future date. The demand prediction unit 23 is, for example, an AI system using machine learning, and predicts demand for an agricultural product on a predetermined future date by using future climate/weather information, information indicating a relationship between the past climate/weather information and the demand, and information regarding dates such as days of the week, seasons, festivals, and events. The future demand information predicted by the demand prediction unit 23 is hereinafter referred to as “predicted demand information”.

Although one producer P1 and one purchaser P2 are illustrated in FIG. 1, there are a plurality of producers P1 and a plurality of purchasers P2. Therefore, the production quantity prediction unit 21 and the quality prediction unit 22 predict the production quantity and the quality for each producer P1. Furthermore, the demand prediction unit 23 predicts the demand for each purchaser P2. While the predicted demand information is used in the present embodiment, information regarding the demand on a predetermined future date may be acquired from the outside instead of the predicted demand information. For example, demand information input by personnel at a middle trader or a retail store may be used.

The transaction system 1 includes a production quantity acquisition unit 11, a quality acquisition unit 12, a production aggregation unit 13, a demand acquisition unit 14, a transaction information collection unit 15, a transaction control unit 16, a delivery destination setting unit 17, and a notification unit 18.

The production quantity acquisition unit 11 acquires a predicted production quantity of an agricultural product on a future date output from the production quantity prediction unit 21.

The quality acquisition unit 12 acquires a predicted quality of the agricultural product on the future date output from the quality prediction unit 22. The quality of the agricultural product includes the variety. The “variety” refers to the type of an agricultural product having a specialized form and a specialized property, such as “XXX orange produced in Ehime Prefecture” and “XXX cabbage produced in Nagano Prefecture”. In a case where the quality of the agricultural product acquired by the quality acquisition unit 12 from the producer P1 is the “variety”, variety information can be acquired directly from the producer P1, not via the quality prediction unit 22. It is also possible to specify the variety of the agricultural product by adding the variety information to the predicted production quantity information. It is also possible to use only the predicted production quantity information, without using the predicted quality information.

The production aggregation unit 13 stores the producer of the agricultural product, the predicted production quantity and the predicted quality of the agricultural product, on the future date, in association with each other. The information associated as described above is hereinafter referred to as “predicted selling information”.

The demand acquisition unit 14 acquires predicted demand information of the agricultural product on the future date output from the demand prediction unit 23.

Alternatively, the production aggregation unit 13 described above may disclose predicted selling information of each producer P1 to a purchaser P2 such as a broker or a retailer, and the purchaser P2 may view the disclosed information and set demand information for a predetermined future date.

The transaction information collection unit 15 generates association information in which the predicted selling information is associated with the predicted demand for each future date, on the basis of the predicted selling information output from the production aggregation unit 13 and the predicted demand information output from the demand acquisition unit 14. The transaction information collection unit 15 outputs the generated association information to the transaction control unit 16.

The association information can be generated by, for example, specifying a date such as XX (day) of XX (month) in XXXX (year) in the future and associating the predicted selling information with the predicted demand on this date. Furthermore, as another example, the date may be relatively specified, such as 10 days later or next Thursday, on the basis of the current date. In a case where a relative date has been set, the relative date may be converted into year-month-day information on the basis of the current date.

The transaction control unit 16 performs matching between the predicted production quantity information and the predicted demand information for an optional date in the future. In the matching, matching is performed on the whole production quantity in the future for each demand in the future first, and in a case where there is a difference, individual adjustment is performed as described later. For example, in a case where a purchaser P2 has input a demand for apples of a quality Y1 (e.g., the variety) but the production quantity of apples of the quality Y1 is smaller than the demand, the purchaser P2 is given a suggestion to change the apples of the quality Y1 to apples of a quality Y2. Alternatively, a suggestion is given to change the apples of the quality Y1 to pineapples of a quality Y3. In this example, the apples of quality Y2 and the pineapples of quality Y3 are suggested as the respective ones for which the demand is smaller than the predicted production quantities.

After the whole matching has been performed, the predicted production quantity information for each producer P1 and the predicted demand information for each purchaser P2 may be matched. For example, a case is assumed in which matching is performed for 5000 kg of apples as a whole. At this stage, the only thing that has been fixed is that transactions of 5000 kg of apples will be implemented on an optional date in the future. Thereafter, 5000 kg of apples are allocated to the producers P1. Allocation is repeated until all of the production quantity of 5000 kg have been allocated, for example, for a producer PIA, 500 kg is allocated to a retailer K1, 400 kg to a retailer K2, and the like. At this time, restrictions may be provided in such a way as to reduce the total delivery distance between the producers P1 and the purchasers P2 such as retailers, the amount of money for the delivery, and the total amount of energy. A specific allocation method will be described later.

In addition, the transaction control unit 16 may establish transactions between the producers P1 and the purchasers P2 by performing matching. In other words, in the example described above, the allocation to each producer P1 is performed after the matching of the total amount of the agricultural product to be produced by each producer P1 is completed, but the individual producers P1 and the purchasers P2 may be directly matched. For example, in a case where the predicted production quantity information indicating that a producer P1 will carry out shipping on a predetermined future date matches the predicted demand information indicating that a purchaser would like to purchase on the predetermined future date, the transaction control unit 16 may match the producer P1 and the purchaser P2.

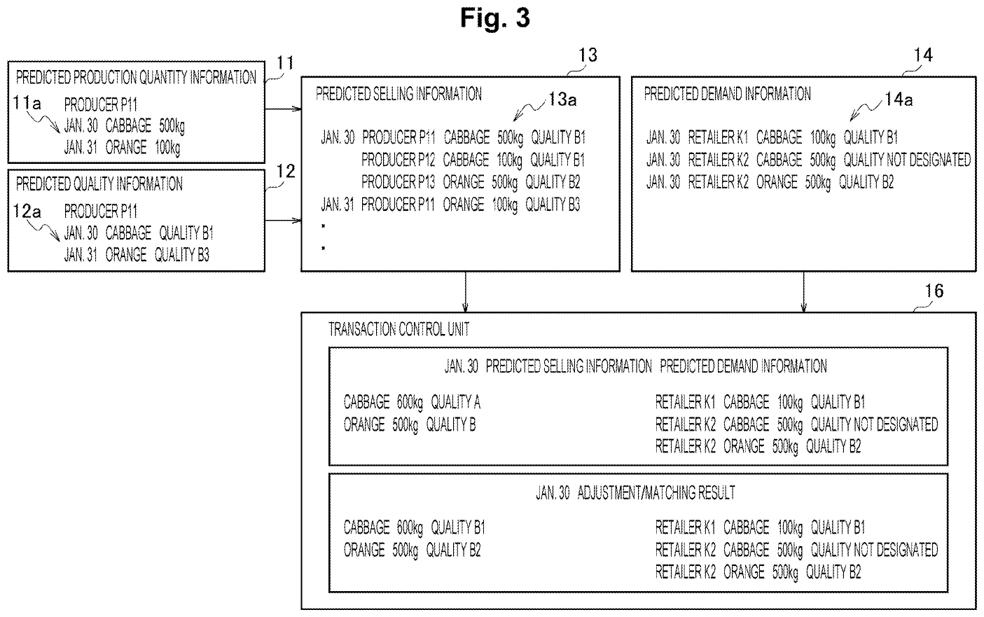

FIG. 3 is an explanatory diagram illustrating labels included in predicted production quantity information, predicted quality information, predicted selling information, and predicted demand information, and a specific allocation method will be described below with reference to FIG. 3. The transaction control unit 16 sets labels for the predicted selling information (predicted production quantity information and predicted quality information) and the predicted demand information. The label set for the predicted production quantity information is information in which at least two of a predetermined future date, a producer, an agricultural product, or a predicted production quantity are associated with each other as indicated by a reference numeral 11a in FIG. 3. The label set for the predicted quality information is information in which at least two of a predetermined future date, a producer, an agricultural product, or a predicted quality are associated with each other as indicated by a reference numeral 12a in FIG. 3.

The label set for the predicted selling information is information included in the reference numerals 11a and 12a as indicated by a reference numeral 13a in FIG. 3. As indicated by a reference numeral 14a in FIG. 3, the predicted demand information is information in which at least two of a predetermined future date, a purchaser (e.g., retailer), an agricultural product, a demand quantity, or a quality are associated with each other.

The transaction control unit 16 matches the label of the predicted selling information acquired from the production aggregation unit 13 with the label of the predicted demand information acquired from the demand acquisition unit 14. Specifically, it is assumed that a label “January 30, cabbage, 500 kg, quality B1” is given as the predicted selling information from the production aggregation unit 13. An example will be described in which the demand acquisition unit 14 has given three predicted demand information labels “January 30, retailer K1, cabbage, 100 kg, quality B1”, “January 30, retailer K2, cabbage, 500 kg, quality not designated”, and “January 30, retailer K2, orange, 500 kg, quality B2”, and matching is performed for these labels.

Since the total demand for cabbage of the quality B1 and quality not designated on January 30 is 600 kg, cabbage with a total production quantity of 600 kg is matched. Furthermore, since the demand for oranges of the quality B2 on January 30 is 500 kg, oranges of the production quantity of 500 kg and the quality B2 are matched.

Next, a case where the label of the predicted selling information and the label of the predicted demand information do not match will be described. For example, it is assumed that a label “January 30, cabbage, 500 kg, quality B1” is given as the predicted selling information from the production aggregation unit 13. In addition, it is assumed that the demand acquisition unit 14 has given three predicted demand information labels “January 30, retailer K1, cabbage, 100 kg, quality B1”, “January 30, retailer K2, cabbage, 300 kg, quality B1”, and “January 30, retailer K2, cabbage, 100 kg, quality B3”.

Since the demand for cabbage of quality B1 on January 30 is 400 kg, 400 kg out of the production quantity of 500 kg is matched. Here, the demands for 100 kg of cabbage of the quality B1 and 100 kg of cabbage of the quality B3 to be produced have not been matched. The business operator providing the transaction system 1 gives a suggestion to the retailer K2 to change 100 kg of cabbage of the quality B3 to 100 kg of cabbage of the quality B1.

In a case where the retailer K2 agrees to the above suggestion, “quality B3” in the label “January 30, retailer K2, cabbage, 100 kg, quality B3” is changed to “quality B1”, and matching is performed again. As a result, the probability of matching can be increased. It is also possible to perform integration with another label that has been matched in advance and includes elements that are common except for the quantity of the label to which a change has been made. That is, matching is preferentially performed for those with the same date, the same agricultural product, and the same quality. The matching may be terminated when the quantity described in the label of the predicted selling information acquired from the production aggregation unit 13 and the total of the quantities that have been matched are the same. In a case where the quantities are not the same, any one of the agricultural product, the quality, and the quantity described in the label may be changed and matching may be performed again. A suggested change may be presented to a purchaser P2 such as a retailer or a producer P1 to make agreement.

When the matching has been completed, all the labels having information of the date for which the matching has been completed are acquired from a database, and associated with the labels related to the demand for which the matching has been completed. For example, a predicted selling information label “January 30, producer P11, cabbage, 500 kg, quality B1” is associated with predicted demand information labels “January 30, retailer K1, cabbage, 100 kg, quality B1” and “January 30, retailer K2, cabbage, 400 kg, quality B1”. Information of labels associated with each other may be output to the delivery destination setting unit 17 to be described later. While a case where the predicted production quantity information and the predicted quality information are simultaneously predicted has been described here, it is also possible to perform matching by using only the date, the agricultural product, the production quantity, and the variety.

While the present embodiment shows an example of matching the predicted production quantity information of the agricultural product with the predicted demand information of the agricultural product, it is also possible to match the predicted selling information including the predicted production quantity information and the predicted quality information with the predicted demand information. By including the predicted quality information, it is possible to perform matching using the quality in addition to the production quantity of the agricultural product as conditions.

In addition, when the transaction control unit 16 performs matching of a transaction of an agricultural product, it is possible to allow a purchaser P2 to designate a specific producer from among a plurality of producers P1 for the matching. By designating the producer, the purchaser P2 can designate, for example, a credible producer and purchase the agricultural product.

In a case where predicted production quantity information provided from producers P1 and predicted demand information indicating requests from purchasers P2 are not matched, the transaction control unit 16 has a function of adjusting at least one of the predicted production quantity information or the predicted demand information, as described above.

For example, in a case where matching is not established because the production quantity of an agricultural product on a predetermined future date is larger than the demand, adjustment is performed in such a way as to increase the demand for the agricultural product on the predetermined date or reduce the production quantity of the agricultural product. Specifically, the transaction control unit 16 lowers the unit price of the farm product for which matching is performed and gives a suggestion to a purchaser P2 to consider whether it is possible to purchase a larger amount of the agricultural product. As a result of the suggestion, if the purchaser P2 can purchase a larger amount of the agricultural product, the matching is established.

In a case where matching is not established because the demand for a predetermined agricultural product on an optional date in the future is larger than the production quantity, adjustment is performed in such a way as to reduce the demand for the predetermined agricultural product or increase the production quantity of the agricultural product. Specifically, the transaction control unit 16 gives a suggestion to the purchaser P2 to consider whether it is possible to purchase shipment of a farm product as a substitute for the predetermined agricultural product for which matching is performed. Examples of this include suggesting apples of a different variety as described above. In this way, the probability of matching can be increased.

The transaction control unit 16 outputs to the notification unit 18, transaction information in which the type, quantity, shipping date, producer P1, and purchaser P2 of a farm product for which the matching has been completed are associated with each other.

The transaction control unit 16 may output the transaction information to the notification unit 18 when it has been confirmed that the purchaser P2 has paid for the agricultural product that is a purchase target after completion of the matching. This makes it possible to prevent non-payment for the agricultural product.

Alternatively, the transaction control unit 16 may advise the purchaser P2 to pay for the agricultural product when receiving a notification indicating that the target agricultural product has been delivered to the delivery destination designated by the purchaser P2. In this way, the purchaser P2 can pay for the agricultural product after confirming that the agricultural product has been delivered. In this case, the business operator providing the transaction system may receive the payment from the purchaser in advance, and pay the producer only for the quantity that has been delivered in a case where the matched agricultural product has not been delivered or has been delivered in a different quantity.

The delivery destination setting unit 17 sets information regarding the delivery destination of the farm product for which matching has been completed. For example, the purchaser of the agricultural product can set, as the delivery destination, a desired place such as a warehouse under the control of the purchaser.

The notification unit 18 notifies the producer P1 and the purchaser P2 for which the matching has been completed, of the transaction information of the agricultural product to be shipped, that is, the type, quantity, shipping date, and transaction amount of the agricultural product. Furthermore, information regarding the delivery destination of the agricultural product is given.

The producer P1 ships the farm product to be shipped to the delivery destination on the shipping date (predetermined future date) described in the notification given from the notification unit 18. A setting may be configured such that the carrier of the agricultural product and the purchaser P2 give a notification of completion of the receipt when the delivery is completed. The notification unit 18 may prompt the purchaser P2 to pay for the agricultural product when receiving the notification indicating that receipt of the agricultural product has been completed.

### Operation of First Embodiment

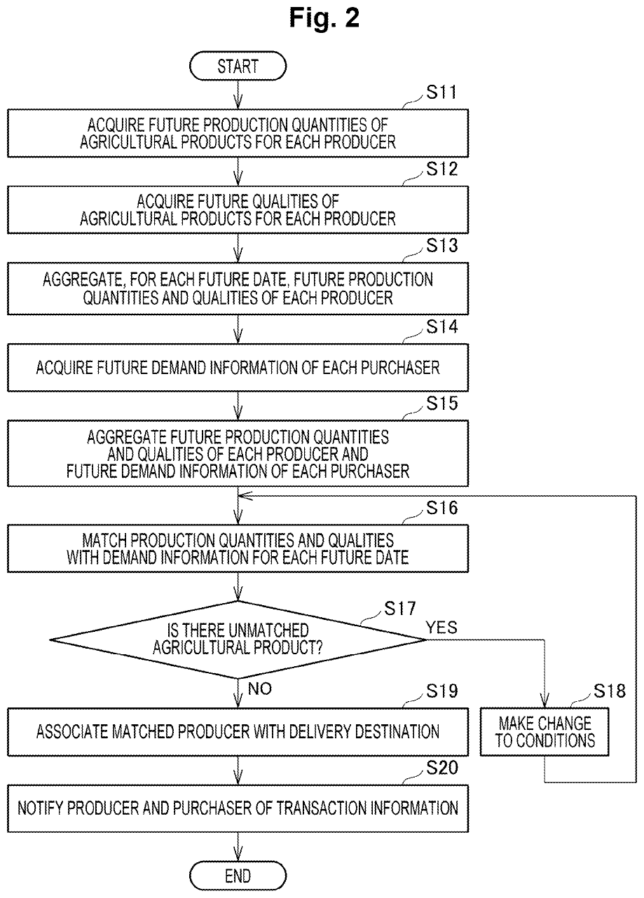

Next, an operation of the first embodiment will be described with reference to a flowchart illustrated in FIG. 2.

First, in step S11 illustrated in FIG. 2, the production quantity acquisition unit 11 acquires predicted production quantities of various agricultural products on a predetermined future date for each producer P1.

Specifically, the predicted production quantities of the agricultural products on the predetermined future date predicted by machine learning or the like in the production quantity prediction unit 21 are acquired. That is, the processing of step S11 is an example of a production quantity acquisition step of acquiring a predicted production quantity of an agricultural product on a predetermined future date for each producer.

At this time, the predicted production quantity information may be configured to retain a label describing “predetermined future date, producer, agricultural product, predicted production”. For example, “January 30, producer P11, cabbage, 500 kg” can be used as a label. A record may be used instead of the label. That is, any means may be used as long as the structure has a large number of columns and aggregation and allocation can be performed later. The created label may be stored in a database (not illustrated). The same applies to labels to be described later.

In step S12, the quality acquisition unit 12 acquires predicted qualities of the various agricultural products to be shipped on the predetermined future date for each producer P1. Specifically, the predicted qualities of the agricultural products that can be shipped on the predetermined future date predicted by machine learning or the like in the quality prediction unit 22 are acquired. As described above, the quality of the agricultural product includes functional components, sugar content, and acidity of the agricultural product.

At this time, “predetermined future date, producer, agricultural product, predicted quality” may be retained as a label. As described above, in a case where the predicted production quantity information and the predicted quality information have been simultaneously deduced, “predetermined future date, producer, agricultural product, predicted production quantity, predicted quality” may be retained as a label. For example, “January 30, producer P11, tomato, lycopene content” may be used as a label. As described above, the variety may be used as an example of the quality. In a case where the variety is used, it is only required to just input the variety, without making a prediction. It is possible to omit the quality acquisition unit 12 illustrated in FIG. 1, and add variety information to the label created by the production quantity acquisition unit 11.

In step S13, the production aggregation unit 13 aggregates, for each future date, the predicted production quantities and the predicted qualities for each producer P1. The aggregation result may be stored as a label. For example, a result of aggregating the predicted production quantity information for each quality of the agricultural product such as “January 30, cabbage, 500 kg, quality B1” or “January 30, 200 kg of tomato, quality B2” may be used as a label. As described above, the variety may be used as an example of the quality.

In step S14, the demand acquisition unit 14 acquires predicted demand information of each purchaser P2 on a predetermined future date from the demand prediction unit 23. Specifically, the predicted demand information for the predetermined future date predicted by machine learning or the like in the demand prediction unit 23 is acquired. That is, the processing of step S14 is an example of a demand acquisition step of acquiring a predicted demand for the agricultural product on the predetermined future date for each purchaser. At this time, the acquired demand may be retained as a label. For example, “January 30, retailer K2, tomato, 100 kg, quality B2” may be used as a label.

The predicted demand information is not limited to information predicted by the demand prediction unit 23, and the purchaser may input the predicted demand information for the future date. For example, in a case where it is known in advance that XXX event will be held after one week and will cause an increase in the demand for XXX (a vegetable), the purchaser can input the predicted demand information.

In step S15, the transaction information collection unit 15 aggregates the predicted selling information (predicted production quantity information and predicted quality information) aggregated by the production aggregation unit 13 and the predicted demand information acquired by the demand acquisition unit 14.

In step S16, the transaction control unit 16 performs matching between the predicted production quantity information and the predicted demand information for each future date. That is, the processing of step S16 is an example of a matching step of performing matching between the predicted production quantity of each producer and the predicted demand of each purchaser on the predetermined date. The matching may be performed between the predicted demand information and the predicted selling information obtained by adding the predicted quality information to the predicted production quantity information.

In step S17, the transaction control unit 16 determines whether there is an agricultural product that has not been matched in the processing of step S16. For example, in a case where a producer P1 has input predicted production quantity information indicating that XXX (quantity) of XXX (agricultural product) can be shipped on XX (day) of XX (month) in XXXX (year), and there is no predicted demand information that matches this predicted production quantity information, it is determined that matching is not established.

If there is an agricultural product that has not been matched (YES in S17), the processing proceeds to step S18, and if not (NO in S17), the processing proceeds to step S19.

In step S18, the transaction control unit 16 gives the purchaser P2 a notification asking to determine whether a change can be made to the conditions such as the predicted demand information. For example, the purchaser P2 is given a suggestion to reduce, or to increase, the quantity of XXX (agricultural product) to be delivered.

If the purchaser P2 has made a change to the predicted demand information, matching between the predicted production quantity information, and the predicted demand information after the change, is repeated again in the processing of step S16.

For example, as described above, a case is assumed in which a label “January 30, cabbage, 500 kg, quality B1” is given as the predicted selling information, and three labels “January 30, retailer K1, cabbage, 100 kg, quality B1”, “January 30, retailer K2, cabbage, 300 kg, quality B1”, and “January 30, retailer K2, cabbage, 100 kg, quality B2” are given as the predicted demand information. In this case, the production quantity of cabbage is 500 kg, and the demand for cabbage is also 500 kg in total.

However, while all the cabbage to be produced is of the quality B1, 100 kg of the cabbage that the retailer K2 wants to purchase is cabbage of the quality B2. Therefore, the label of the predicted selling information and the label of the predicted demand information are not matched. In such a case, the business operator of the transaction control unit 16 gives a suggestion to the retailer K2 to change the quality. Specifically, a suggestion to consider whether 100 kg of cabbage of the quality B2 can be changed to cabbage of the quality B1 is given. In a case where the retailer K2 has accepted this suggestion, it is determined that the matching has been established.

In step S19, the transaction control unit 16 associates the producer P1 for which the matching has been completed with the delivery destination desired by the purchaser P2. Specifically, the transaction control unit 16 prompts the purchaser P2 to input information of the delivery destination of the agricultural product, and in a case where the delivery destination is input by the purchaser P2, the delivery destination setting unit 17 sets the delivery destination to which the agricultural product is to be delivered by the producer P1.

In step S20, the notification unit 18 notifies the producer P1 and the purchaser P2 of transaction information in which pieces of information regarding the type of an agricultural product, the quantity, the transaction amount, the shipping date, the producer P1, and the purchaser P2 in which matching is established by the transaction control unit 16 are associated with each other. That is, the processing of step S20 is an example of a notification step of notifying a producer for which the matching has been established of a delivery destination desired by a purchaser for which the matching has been established, information of the agricultural product to be delivered (information including the type and quantity of the agricultural product), and the predetermined date. For example, from the label information “January 30, retailer K1, cabbage, 100 kg, quality B1” and “January 30, retailer K2, cabbage, 400 kg, quality B1” described above, delivery destination information of the retailer K1 and the retailer K2 may be acquired and given to the producer described above.

The producer P1 for which the matching has been completed refers to the transaction information and delivers a predetermined quantity of a predetermined type of an agricultural product to the delivery destination on the desired delivery date designated by the purchaser P2. As a result, the purchaser P2 can receive the desired agricultural product.

### Effects of First Embodiment

As described above, the transaction system 1 according to the first embodiment, which is the transaction system 1 for trading agricultural products between producers and purchasers, includes the production quantity acquisition unit 11 that acquires a predicted production quantity of an agricultural product on a predetermined future date, the demand acquisition unit 14 that acquires a predicted demand for the agricultural product on the predetermined date for each purchaser, the transaction control unit 16 that matches the predicted production quantity with the predicted demand on the predetermined date, and the notification unit 18 that notifies a producer for which the matching has been established of a delivery destination desired by a purchaser for which the matching has been established, information of the agricultural product to be delivered, and the predetermined date.

In the transaction system 1 according to the first embodiment described above, the producer P1 can recognize in advance the purchaser P2 with whom a transaction of the agricultural product on the predetermined future date is established. This allows the producer P1 to deliver the agricultural product directly to the delivery destination designated by the purchaser P2 without temporarily concentrating the agricultural product to be shipped in a central wholesale market or the like. Thus, it is possible to shorten the distribution channel for delivering the agricultural product. It is also possible to shorten the time required for delivery and reduce consumed energy. In addition, it is possible to avoid occurrence of problems such as deterioration of the agricultural product due to change over time.

That is, the transaction system 1 according to the present embodiment can establish a transaction between a producer P1 and a purchaser P2 without sending a farm product to a market or the like in which an agreement on selling and purchase is formed.

Furthermore, the transaction system 1 according to the present embodiment establishes a transaction with a purchaser P2 for a farm product scheduled to be produced in the future. As a result, the purchaser P2 can receive a stable supply of the farm product even in a case where the producer serving as a predetermined trade connection is not specified.

The above-described embodiment has shown an example in which matching is performed between predicted production quantity information and predicted demand information of an agricultural product, but matching may be performed with predicted quality information added to the predicted production quantity information. As described above, the quality of the agricultural product includes functional components, sugar content, and acidity of the agricultural product, and matching can be performed with these qualities added to the conditions.

### Description of First Modification Example

Next, a first modification example of the first embodiment will be described. The first embodiment described above has shown an example of associating a producer P1 with a delivery destination desired by a purchaser P2 in the processing of step S19.

In the first modification example, the transaction control unit 16 performs matching with information of the delivery destination desired by the purchaser P2 included. That is, the first modification example is different from the first embodiment described above in the processing of step S19 illustrated in FIG. 2. This will be described below in more detail.

After completion of matching between the predicted production quantity information of the agricultural product provided by the producer P1 and the predicted demand information of the purchaser P2 in the processing of step S16, the transaction control unit 16 performs processing of associating the producer P1 with the delivery destination desired by the purchaser P2. For example, the delivery destination desired by the purchaser P2 may be added to the label created by the demand acquisition unit 14. Examples include “January 30, retailer K2, cabbage, 100 kg, quality B1, delivery destination Z1” and “January 30, retailer K2, cabbage, 50 kg, quality B1, delivery destination Z2”.

This processing may determine any of the followings: a plurality of producers P1 and one delivery destination, one producer P1 and one delivery destination, one producer P1 and a plurality of delivery destinations, and a plurality of producers and a plurality of delivery destinations.

The transaction control unit 16 selects a producer such that any one of the delivery distance from the producer to the delivery destination, the cost required for delivery, and the energy consumed by delivery is minimized, performs matching on this producer, and configures a setting so that the producer delivers the agricultural product to the delivery destination. An example of selecting a producer such that the delivery distance is minimized will be described below.

It is assumed that 10 boxes of tomatoes of a variety X are matched with a certain purchaser on a predetermined future date. In addition, it is assumed that a first producer Pa produces 6 boxes of tomatoes, a second producer Pb produces 5 boxes of tomatoes, and a third producer Pc produces 15 boxes of tomatoes on the predetermined date.

Furthermore, it is assumed that the distance from the first producer Pa to the delivery destination is 100 km, the distance from the second producer Pb to the delivery destination is 150 km, and the distance from the third producer Pc to the delivery destination is 400 km. The delivery distance when the third producer Pc delivers 10 boxes of tomatoes is 400 km. On the other hand, the total delivery distance when 10 boxes of tomatoes in total are delivered by the first producer Pa and the second producer Pb is 250 km (<400 km). Therefore, in such a case, it is determined that a total of 10 boxes of tomatoes are to be delivered from the first producer Pa and the second producer Pb.

While the above example has shown an example in which the delivery source is the producer P1, the delivery source may be set on a shipping organization-by-shipping organization basis or on a region-by-region basis. In addition, the example described above has shown an example of minimizing the delivery distance, but it is also possible to adopt a similar criterion and configure a setting such that the cost required for transportation or the consumed energy is minimized.

As described above, in the first modification example, the producer P1 is set such that any one of the delivery distance, the cost required for delivery, and the consumed energy required for delivery is minimized, and this allows the time and cost required for delivery to be reduced.

### Description of Second Modification Example

Next, a second modification example will be described. In the first embodiment described above, an example has been described in which matching is performed between predicted production quantity information and predicted demand information, and an agricultural product is traded between a producer P1 and a purchaser P2 for which matching has been established.

In the second modification example, predicted production quantity information and predicted quality information are presented to a plurality of purchasers P2 in advance, and each purchaser P2 refers to the predicted production quantity information and the predicted quality information of an agricultural product on a predetermined future date, and then inputs (bids) a desired purchase price for the agricultural product to the transaction information collection unit 15. The transaction information collection unit 15 outputs, to the transaction control unit 16, the predicted production quantity information, the predicted demand information, and the desired purchase price input by each purchaser P2.

The transaction control unit 16 refers to the desired purchase prices for the agricultural product, and performs matching with a purchaser P2 who has presented the highest purchase price on an optional date. As a result, the producer P1 of the agricultural product can sell the agricultural product to the purchaser P2 who has presented the higher price. For example, the desired purchase price may be added to the label created by the demand acquisition unit 14. Examples of the configuration of the label include “January 30, retailer K2, cabbage, 100 kg, quality B1, desired purchase price XX yen”.

Instead of determining matching by one bidding, a plurality of purchasers P2 may access the transaction information collection unit 15 at a predetermined date and time to refer to the predicted production quantity information and the predicted quality information presented on the transaction system 1, and participate in the bidding. Each purchaser P2 presents a purchase price for a desired agricultural product (price presentation step), and the transaction control unit 16 performs matching between the producer and the purchaser who has presented the highest purchase price. For example, among labels with the same date, the same agricultural product, and the same quality, matching is preferentially performed on a label with the highest purchase price in a desired purchase price column.

Alternatively, as in an online auction, it is possible to accept bids from a plurality of purchasers during a period set in advance, and allow each purchaser to refer to the prices offered by other purchasers and repeatedly tender a bid for each piece of predicted production quantity information and predicted quality information. Thus, the producer P1 can sell the agricultural product at a higher price.

### Configuration of Second Embodiment

Next, a second embodiment will be described. FIG. 3 is a block diagram illustrating a configuration of a transaction system 1a according to the second embodiment, an arithmetic device 100a, and peripheral equipment thereof. The transaction system 1a according to the second embodiment implements transactions of agricultural products between a shipping organization 30 constituted by a plurality of producers P1 and purchasers P2 such as brokers and retailers. As in the first embodiment described above, the transactions may be implemented on a producer-by-producer basis. Alternatively, the transactions may be implemented on a region-by-region basis, on a market-by-market basis, or on a business operator-by-business operator basis.

The transaction system 1a illustrated in FIG. 3 is different from the first embodiment described above in that the production quantity and quality in the future are predicted for each shipping organization 30 and a process processing unit 19 is provided. Processing performed by a transaction information collection unit 15, a transaction control unit 16, and a notification unit 18 is also different. This will be described below in more detail.

The process processing unit 19 is, for example, a process plant for processing and packaging an agricultural product, in which an agricultural product shipped from a shipping organization 30 is processed, and the processed agricultural product is delivered to a delivery destination desired by a purchaser P2. The “process processing” refers to processing of performing some sort of operation on the agricultural product to be delivered to the purchaser P2, such as processing of cutting the agricultural product into pieces of an optional size, processing of tying the agricultural product into bundles each including a predetermined number of pieces, and processing of packaging the agricultural product.

The transaction information collection unit 15 acquires corresponding information regarding the shipping organization 30 and the process processing unit 19, in addition to having the functions described in the first embodiment described above. Furthermore, the transaction information collection unit 15 acquires information regarding whether the purchaser P2 desires process processing of the agricultural product to be purchased.

The transaction control unit 16 adds information related to process processing to transaction information obtained as a result of matching, and then outputs the information to the notification unit 18. The information related to process processing includes the corresponding information regarding the shipping organization 30 and the process processing unit 19, and the information regarding whether the purchaser P2 desires process processing of the agricultural product.

The transaction control unit 16 may perform matching using available process processing as a restriction condition according to geographical conditions of the area where the process processing unit 19 is arranged. For example, a restriction that cutting of agricultural products is available is set for a process processing unit 19 arranged in a first area, and producers using the first area may exclude the purchaser P2 from the matching in a case where the purchaser P2 desires packaging.

In a case where the transaction information includes the information related to process processing, the notification unit 18 designates a desired process processing unit 19 (e.g., a process plant) as the delivery destination.

The process processing unit 19 acquires, from the notification unit 18, process information of the farm product delivered from the producer P1 and the delivery destination thereof, and specifies the details of the process processing and the delivery destination. Here, the delivery destination is a delivery destination desired by the purchaser P2 such as a retail store. For each farm product, a label indicating details of process processing and a delivery destination may be newly given and identified. The process processing unit 19 processes the farm product on the basis of results of the specification, and delivers the farm product to the specified delivery destination.

### Operation of Second Embodiment

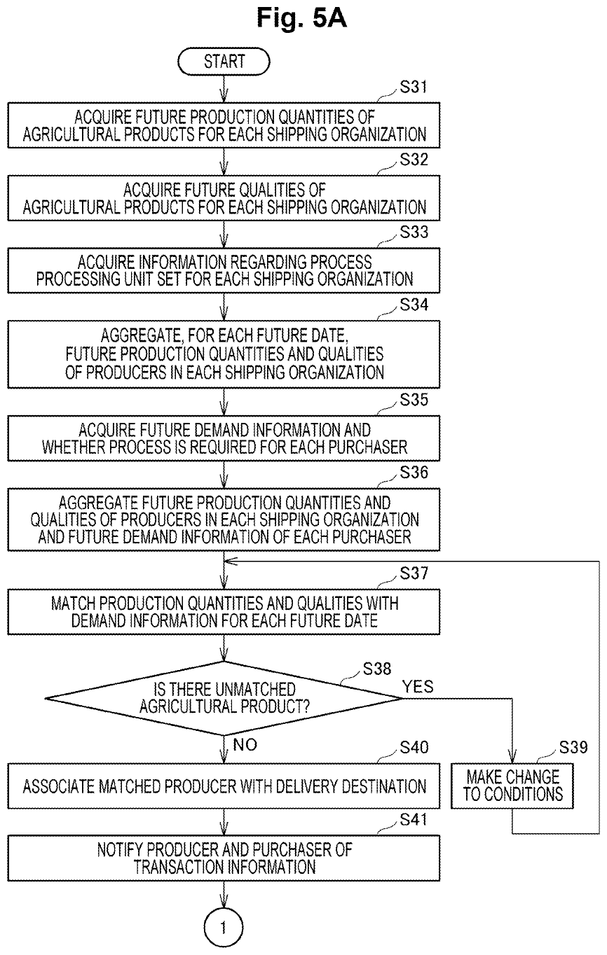

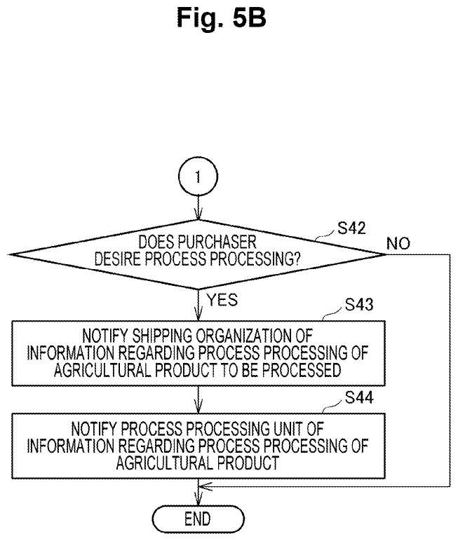

Next, a processing procedure of the transaction system 1a according to the second embodiment will be described with reference to flowcharts illustrated in FIGS. 5A and 5B.

First, in step S31 illustrated in FIG. 5A, a production quantity acquisition unit 11 acquires predicted production quantities of various agricultural products on a predetermined future date for each shipping organization 30. Specifically, the predicted production quantities of the agricultural products on the predetermined future date predicted by machine learning or the like in a production quantity prediction unit 21 are acquired.

In step S32, a quality acquisition unit 12 acquires predicted qualities of the various agricultural products to be shipped on the predetermined future date for each shipping organization 30. Specifically, the predicted qualities of the agricultural products that can be shipped on the predetermined future date predicted by machine learning or the like in a quality prediction unit 22 are acquired.

In step S33, the transaction control unit 16 acquires information regarding the process processing unit 19 set for each shipping organization 30. Specifically, in a case where an exclusive process processing unit 19 has been set for each shipping organization 30, process availability information indicating the geographical conditions of the process processing unit 19 and available process processing (e.g., cutting, bagging, or packaging) is acquired. That is, the processing of step S33 is an example of a process availability information acquisition step of acquiring process availability information indicating whether the producer is capable of performing process processing on the agricultural product.

In step S34, a production aggregation unit 13 aggregates, for each future date, the predicted production quantities and the predicted qualities for each shipping organization 30.

In step S35, a demand acquisition unit 14 acquires a predicted demand of each purchaser P2 on a predetermined future date from a demand prediction unit 23.

Specifically, the predicted demand information for the predetermined future date predicted by machine learning or the like in the demand prediction unit 23 is acquired. The predicted demand information is not limited to information predicted by the demand prediction unit 23, and the purchaser may input the predicted demand information for the future date.

Furthermore, in step S35, the transaction information collection unit 15 acquires desired process information indicating whether the purchaser P2 wants the agricultural product to be processed. That is, the processing of step S35 is an example of a desired process information acquisition step.

In step S36, the transaction information collection unit 15 aggregates predicted selling information (predicted production quantity information and predicted quality information) aggregated by the production aggregation unit 13 and the predicted demand information acquired by the demand acquisition unit 14.

In step S37, the transaction control unit 16 performs matching between the predicted production quantity information and the predicted demand information for each future date. The matching may be performed between the predicted demand information and the predicted selling information obtained by adding the predicted quality information to the predicted production quantity information.

In step S38, the transaction control unit 16 determines whether there is an agricultural product that has not been matched in the processing of step S37.

If there is an agricultural product that has not been matched (YES in S38), the processing proceeds to step S39, and if not (NO in S38), the processing proceeds to step S40.

In step S39, the transaction control unit 16 gives the purchaser P2 a notification asking to determine whether a change can be made to the conditions such as the predicted demand information. For example, the purchaser P2 is given a suggestion to reduce, or to increase, the quantity of XXX (agricultural product) to be delivered.

If the purchaser P2 has made a change to the predicted demand information, matching between the predicted production quantity, and the predicted demand information after the change, is repeated again in the processing of step S37.

In step S40, the transaction control unit 16 associates the producer P1 for which the matching has been completed with the delivery destination desired by the purchaser P2. Specifically, the transaction control unit 16 prompts the purchaser P2 to input information of the delivery destination of the agricultural product, and in a case where the delivery destination is input by the purchaser P2, a delivery destination setting unit 17 sets the delivery destination to which the agricultural product is to be delivered by the producer P1.

In step S41, the notification unit 18 notifies the producer P1 and the purchaser P2 of transaction information in which pieces of information regarding the type of an agricultural product, the quantity, the transaction amount, the shipping date, the producer P1, and the purchaser P2 in which matching is established by the transaction control unit 16 are associated with each other.

In step S42 in FIG. 5B, the transaction control unit 16 determines whether the purchaser P2 wants the agricultural product to be processed. If process processing is desired (YES in S42), the processing proceeds to step S43, and if not (NO in S42), this processing ends.

In step S43, the notification unit 18 notifies the shipping organization 30 of the process information of the agricultural product to be subjected to process processing. The process information includes information regarding the type of processing such as cutting, bagging, or packaging of the agricultural product, and information regarding the quality, quantity, and type of the agricultural product to be processed. Furthermore, the notification unit 18 notifies the shipping organization 30 of the delivery destination of the agricultural product after the process processing. That is, the processing of step S43 is an example of a process processing notification step of notifying the process processing unit 19 of information regarding process processing in a case where the purchaser wants the agricultural product to be processed, the agricultural product being delivered from the producer for which the matching has been established.

In step S44, the notification unit 18 notifies the process processing unit 19 of the process information of the agricultural product to be subjected to process processing.

The process processing unit 19 performs process processing on the target agricultural product on the basis of the process information described above. The process processing unit 19 delivers the agricultural product after the process processing, to the delivery destination designated by the purchaser P2. As a result, the purchaser P2 can acquire the agricultural product delivered from the shipping organization 30 with the agricultural product having been subjected to a predetermined type of process processing.

As exemplified in the above embodiments, a case where labels are used will be described. For example, desired process information indicating the process desired by the purchaser may be added to the label created by the demand acquisition unit 14. Examples of the configuration of the label include “January 30, retailer K2, cabbage, 100 kg, quality B1, desired process information”.

On the basis of the information on this label, the delivery destination setting unit 17 may generate a label to be sent to the producer P1 and a label to be sent to the process processing unit. For example, the producer P1 and the process processing unit 19 may be respectively informed of a label “January 30, process plant Q1, cabbage, 100 kg, quality B1” generated for the producer and a label “January 30, cabbage, 100 kg, quality B1, desired process information, desired delivery destination” generated for the process processing unit 19. With this configuration, the producer P1 and the process processing unit 19 are only required to perform delivery and the process on the basis of the information described in the labels, and management is not required.

### Effects of Second Embodiment

As described above, the transaction system 1a according to the second embodiment acquires the process availability information indicating whether the purchaser P2 wants the purchased agricultural product to be processed, and in a case where the purchaser P2 wants the agricultural product to be processed, the transaction system 1a notifies the shipping organization 30 and the process processing unit 19 of this information. In a case where the matching has been completed, the producer P1 of the shipping organization 30 delivers, to the process processing unit 19, the agricultural product to be delivered to the purchaser P2. The process processing unit 19 performs process processing such as cutting, bagging, or packaging on the agricultural product, and then delivers the processed agricultural product to the delivery destination designated by the purchaser P2.

Therefore, in a case where the purchaser P2 desires process processing, the shipping organization 30 is only required to deliver the produced agricultural product to the process processing unit 19 (e.g., a process plant) as it is. This eliminates the need for the shipping organization 30 to perform process processing such as cutting, bagging, and packaging, thereby reducing the burden on the shipping organization 30. In addition, the agricultural product to be delivered to the purchaser P2 is transported from the shipping organization 30 to the process processing unit and further to the delivery destination, and thus can be delivered in the shortest distance.

In addition, the process processing unit 19 is informed in advance of the process information, and this makes it possible to arrange in advance personnel who performs process processing on the agricultural product, and efficiently proceed with the work.

### Configuration of Third Embodiment

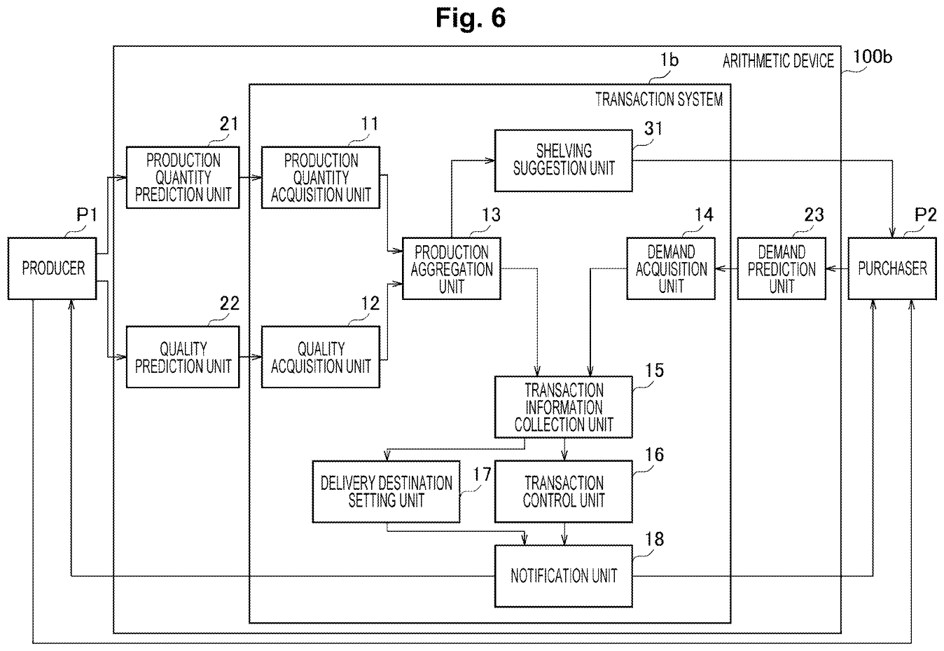

Next, a third embodiment will be described. FIG. 6 is a block diagram illustrating a configuration of a transaction system 1b according to the third embodiment, an arithmetic device 100b, and peripheral equipment thereof.

The transaction system 1b illustrated in FIG. 6 is different from the first embodiment described above in that a shelving suggestion unit 31 is provided. Other components are similar to those in the first embodiment illustrated in FIG. 1 and denoted by the same reference numerals, and thus a description of the components will be omitted.

In the present embodiment, “shelving” means selling agricultural products such as vegetables at lower prices than usual in a retail store or the like, that is, so-called “special sale”. That is, in a “shelving suggestion”, the transaction system 1b makes a suggestion to a purchaser P2 such as a retailer to sell at a price lower than usual, such as a special sale.

The shelving suggestion unit 31 acquires predicted production quantity information of an agricultural product on a predetermined future date. In a case where the production quantity of an agricultural product on the predetermined future date is larger than before (e.g., larger than the production quantity several days before), the production quantity of the agricultural product on the predetermined date is expected to exceed the demand. That is, (production quantity in the future)> (demand in the future) is expected for the agricultural product.

The shelving suggestion unit 31 makes, to the purchaser P2 such as a retailer, a shelving suggestion such as holding a special sale or increasing the demand for the agricultural product described above. In a case where the purchaser P2 agrees to this suggestion, the transaction control unit 16 determines that matching for the agricultural product has been completed.

### Operation of Third Embodiment

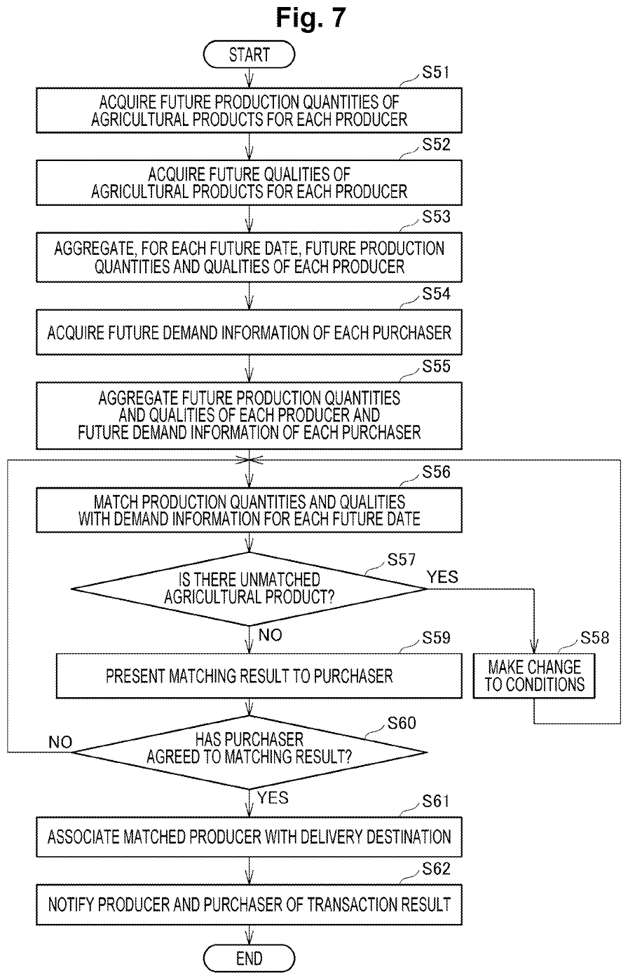

Next, a processing procedure of the transaction system 1b according to the third embodiment will be described with reference to a flowchart illustrated in FIG. 7. The processing of steps S51 to S55 illustrated in FIG. 7 is the same as the processing of steps S11 to S15 illustrated in FIG. 2, and thus a description thereof will be omitted.

In step S56, the transaction control unit 16 performs matching between the predicted production quantity information and the predicted demand information for each future date. At this time, even in a case where the predicted production quantity is larger than the predicted demand, these pieces of information are matched.

In step S57, the transaction control unit 16 determines whether there is an agricultural product that has not been matched in the processing of step S56.

If there is an agricultural product that has not been matched (YES in S57), the processing proceeds to step S58, and if not (NO in S57), the processing proceeds to step S59.

In step S58, the transaction control unit 16 gives the purchaser P2 a notification asking to determine whether a change can be made to the conditions such as the predicted demand information.

If the purchaser P2 has made a change to the predicted demand information, matching between the predicted production quantity, and the predicted demand information after the change, is repeated again in the processing of step S56.

In step S59, the transaction control unit 16 presents a matching result to the purchaser P2. In a case where the predicted production quantity for which matching has been completed is larger than the predicted demand, the shelving suggestion unit 31 makes a suggestion to the purchaser P2 to perform shelving. That is, the processing of step S59 is an example of a shelving suggestion step of suggesting the purchaser P2 to perform shelving in a case where the predicted production quantity is larger than the predicted demand.

That is, in a case where the predicted production quantity information for the predetermined date for which the matching has been established is larger than the predicted demand information, the possibility of failing to sell out the delivered farm products increases. Therefore, the transaction control unit 16 presents the matching result to the purchaser P2, and the shelving suggestion unit 31 makes a suggestion to the purchaser P2 to perform shelving.

In step S60, the transaction control unit 16 determines whether the purchaser P2 has agreed to the matching result after viewing the matching result and the shelving suggestion described above. If agreed (YES in S60), the processing proceeds to step S61, and if not (NO in S60), the processing returns to step S56.

In step S61, the transaction control unit 16 associates information regarding the producer P1 for which the matching has been completed with information regarding the delivery destination desired by the purchaser P2. Specifically, the transaction control unit 16 prompts the purchaser P2 to input information regarding the delivery destination of the agricultural product. In a case where the delivery destination is input by the purchaser P2, the delivery destination setting unit 17 sets the delivery destination to which the agricultural product is to be delivered by the producer P1.

In step S62, the notification unit 18 notifies the producer P1 and the purchaser P2 of transaction information in which pieces of information regarding the type of an agricultural product, the quantity, the transaction amount, the shipping date, the producer P1, and the purchaser P2 in which matching is established by the transaction control unit 16 are associated with each other.

The producer P1 for which the matching has been completed refers to the transaction information and delivers a predetermined quantity of a predetermined type of an agricultural product to the delivery destination on the desired delivery date designated by the purchaser P2. As a result, the purchaser P2 can receive the desired agricultural product. In addition, the purchaser P2 who is given a suggestion to hold a special sale by the shelving suggestion unit 31 can perform in advance work such as preparing a store shelf for holding a special sale.

### Effects of Third Embodiment

As described above, the transaction system 1b according to the third embodiment yields effects similar to those of the first embodiment described above.

Furthermore, in the transaction system 1b according to the third embodiment, the shelving suggestion unit 31 makes a suggestion to the purchaser P2 to perform shelving such as holding a special sale. Therefore, even in a case where the predicted production quantity information is larger than the predicted demand information, it is possible to match these pieces of information, and thus increase the probability of establishing the transaction.

In addition, the shelving suggestion unit 31 makes a suggestion to the purchaser P2 to hold a special sale, and this allows the purchaser P2 to make preparations in advance for holding a special sale, and the agricultural product can be easily sold even in a case where the quantity of the agricultural product which is larger than the predicted demand is delivered.

While step S60 described above has shown an example in which the purchaser P2 determines whether to agree to the matching, it is also possible to set whether to automatically agree to matching for a farm product with (production quantity in the future)>(demand in the future).

For example, the sales volume at a desired date and time is predicted for each purchaser P2, and the transaction control unit 16 can automatically perform matching so that a purchase for the sales volume is conducted.

The purchaser P2 may set the maximum purchase price, the minimum purchase quantity, and the maximum purchase quantity for each desired period such as every day or every week. Automatic matching based on such setting conditions allows the purchaser P2 to have a farm product delivered to the delivery destination desired by the purchaser P2 according to the predicted sales volume and the conditions, without the purchaser P2 conducting purchasing. This allows the purchaser P2 to stably receive the agricultural product, and reduce loss of the agricultural product.

Instead of using a result of matching performed by the transaction control unit 16 as it is, it is possible to allow a determination of the purchaser P2 to intervene in the matching result. For example, it is possible to allow the purchaser P2 to give approve to a result of matching by means of the transaction control unit 16. In this case, it is possible to provide a presentation unit (not illustrated) for presenting a result of matching by means of the transaction control unit 16 to the purchaser P2 and presenting whether to approve or disapprove.

In a case where the purchaser does not approve, additional information may be acquired from the purchaser, and the matching may be performed again in consideration of the acquired information. Examples of the additional information may include a restriction on the type, quantity, or the like of the farm product, and a restriction for reducing the demand to zero on a presented future date.

In a case where the purchaser has designated agreement under any condition, the above-described approval procedure may be omitted, and the matching result may be used as it is.

Furthermore, the purchaser P2 may be allowed to adjust the type and quantity of the agricultural product. In this case, a presentation adjustment unit (not illustrated) may be provided which can present a result of matching by means of the transaction control unit 16 to the presentation unit and adjust the type and quantity of the farm product.

In a case where the purchaser P2 has not input anything on the presentation unit or the presentation adjustment unit within a predetermined time limit, matching may be performed again, excluding the purchaser P2 who has not input anything.

A transaction has conventionally been established with the price of the farm product set to an extremely low price in a case where the production quantity is larger than the demand. In the transaction system 1b according to the third embodiment, the future demand can be increased in advance according to the production quantity in the future, and thus a transaction can be established without lowering the price of the agricultural product.

In addition, in a case where the sales volume is predicted for each purchaser P2, the purchasers P2 can purchase the farm product according to the predicted sales volume, and thus, it is possible to minimize the loss such as disposal of the agricultural product while satisfying the demand of end users.

Note that, in the transaction systems 1, 1a, and 1b described in the above-described embodiments, an example of trading an agricultural product produced by a producer P1 has been described, but the transaction systems can also be adopted to, for example, the cases where fish, shellfish, and livestock are traded, besides agricultural products.

In each embodiment described above, an example of matching the predicted production quantity information and the predicted demand information for a predetermined future date has been described, but it is also possible to match the predicted production quantity information and the predicted demand information in a range of a predetermined period (e.g., two days, three days, or one week), instead of a predetermined date.

The predicted demand information is not limited to prediction by machine learning or the like, and the predicted demand information may be input by a purchaser P2 or the like.

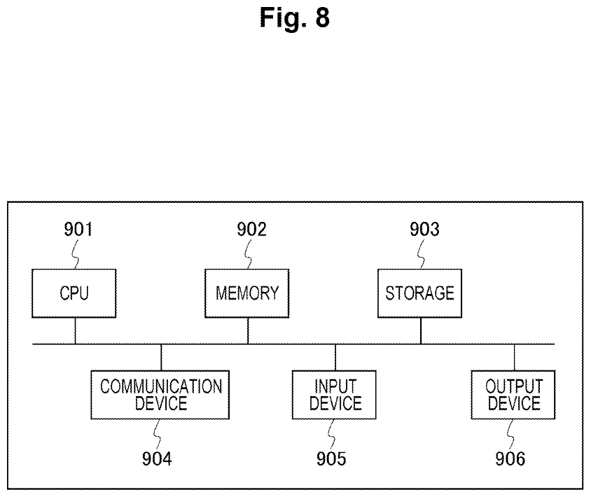

As illustrated in FIG. 8, for example, a general-purpose computer system including a central processing unit (CPU, processor) 901, a memory 902, a storage 903 (hard disk drive: HDD, solid state drive: SSD), a communication device 904, an input device 905, and an output device 906 can be used as the transaction system 1 of the present embodiment described above. The memory 902 and the storage 903 are storage devices. In the computer system, each function of the transaction system 1 is implemented by the CPU 901 executing a predetermined program loaded on the memory 902.

The transaction system 1 may be implemented by one computer, or may be implemented by a plurality of computers. In addition, the transaction system 1 may be a virtual machine that is implemented in a computer.

A program for the transaction system 1 can be stored in a computer-readable recording medium such as an HDD, an SSD, a universal serial bus (USB) memory, a compact disc (CD), or a digital versatile disc (DVD), or can be distributed via a network.

The present invention is not limited to the above embodiments, and various modifications can be made within the scope of the spirit of the present invention.

### REFERENCE SIGNS LIST

1, 1a, 1b Transaction system
11 Production quantity acquisition unit
12 Quality acquisition unit
13 Production aggregation unit
14 Demand acquisition unit
15 Transaction information collection unit
16 Transaction control unit
17 Delivery destination setting unit
18 Notification unit
19 Process processing unit
21 Production quantity prediction unit
22 Quality prediction unit
23 Demand prediction unit
30 Shipping organization
31 Shelving suggestion unit
100, 100a, 100b Arithmetic device
P1 Producer
P2 Purchaser

1. A transaction method for trading agricultural products between producers and purchasers executed by a transaction system, the transaction method comprising:
a production quantity acquisition step of acquiring a predicted production quantity of an agricultural product on a predetermined future date for each producer;
a demand acquisition step of acquiring a predicted demand for the agricultural product on the predetermined date for each purchaser;
a matching step of performing matching between the predicted production quantity of each producer and the predicted demand of each purchaser on the predetermined date; and
a notification step of notifying a producer for which the matching has been established of a delivery destination desired by a purchaser for which the matching has been established, information of the agricultural product to be delivered, and the predetermined date.

2. The transaction method according to claim 1, further comprising:
a price presentation step of presenting purchase prices for the agricultural product by the purchasers, wherein
in the matching step, in a case where there are predicted demands of a plurality of purchasers which are matched with a predicted production quantity of one producer, the producer is matched with a purchaser who has presented a highest purchase price among the plurality of purchasers.

3. The transaction method according to claim 1 or 2, wherein
at least one of a delivery distance from each producer to the delivery destination, a cost required for delivery, or energy consumed by delivery is acquired, and
in the matching step, matching between a predicted production quantity of each producer and a predicted demand of each purchaser on the predetermined date is performed on condition that at least one of the delivery distance, the cost required for delivery, or the energy consumed by delivery is minimized.

4. The transaction method according to claim 1, further comprising:
a process availability information acquisition step of acquiring process availability information indicating whether the producer is capable of performing process processing on the agricultural product; and
a desired process information acquisition step of acquiring desired process information indicating whether the purchaser wants the agricultural product to be processed, wherein
in the matching step, matching is performed based on the process availability information and the desired process information.

5. The transaction method according to claim 1, further comprising:
a process processing notification step of notifying a process processing unit that processes the agricultural product of information regarding process processing in a case where the purchaser wants the agricultural product to be processed, the agricultural product being delivered from the producer for which the matching has been established.

6. The transaction method according to claim 1, further comprising:
a shelving suggestion step of suggesting shelving for increasing a demand of the purchaser in a case where the predicted production quantity is larger than the predicted demand.

7. A transaction system for trading agricultural products between producers and purchasers, the transaction system comprising:
a production quantity acquisition unit that acquires a predicted production quantity of an agricultural product on a predetermined future date;
a demand acquisition unit that acquires a predicted demand for the agricultural product on the predetermined date for each purchaser;
a transaction control unit that matches the predicted production quantity with the predicted demand on the predetermined date; and
a notification unit that notifies a producer for which the matching has been established of a delivery destination desired by a purchaser for which the matching has been established, information of the agricultural product to be delivered, and the predetermined date.

8. A non-transitory computer-readable storage medium storing a transaction program for causing a computer to function as the transaction system according to claim 7.
